(19) United States
(12) Patent Application Publication
(10) Pub. No.: US 2015/0090432 A1
(43) Pub. Date: Apr. 2, 2015

(54) LOW-PRESSURE THIN-WALLED HEAT EXCHANGER AND METHOD OF MAKING SAME

(71) Applicant: ALUMINIUM FERON GMBH & CO., KG, Düren (DE)

(72) Inventors: Bert Féron, Kreuzau (DE); Manfred Breuer, Bergheim (GB)

(21) Appl. No.: 14/387,356

(22) PCT Filed: Mar. 15, 2013
(86) PCT No.: PCT/DE2013/000150

§ 371 Date: Sep. 24, 2014

(30) Foreign Application Priority Data
Mar. 28, 2012 (DE) 10 2012 006 324.5
Jun. 23, 2012 (DE) 10 2012 012 711.1

(51) Int. Cl. F28F 21/08; B32B 37/00; B32B 38/06; B32B 37/12; B32B 37/18

(52) U.S. Cl. CPC F28F 21/081; B32B 37/1284; B32B 37/182; B32B 38/06; B32B 37/0076; B32B 2311/24; B32B 2398/00; B32B 2307/302
USPC 165/168; 156/60; 156/182; 156/306.6; 156/219; 156/222

(57) ABSTRACT

A method of making a low-pressure thin-walled heat exchanger and a low-pressure thin-walled heat exchanger are described. According to the production method a thin metal cover layer and a thin cover layer consisting of metal or plastic are sealed with one another. The sealing is realized by a thin layer of a sealable polymer that is provided as coating on one side of at least one cover layer and/or by a separate intermediate layer of a sealable polymer. Both cover layers are sealed with one another by the interposed layer of the sealable polymer with the formation of a cavity suitable for the passage of a heat exchange medium which cavity can be formed as passage system. Such heat exchangers can be produced in an especially cheap way in this manner.

The present invention is directed to a method of making a low-pressure thin-walled heat exchanger.

It is known to produce heat exchangers by connecting two metal layers of which at least one has an embossed passage system for a heat exchange medium. So, for instance, a heat exchanger formed as modular solar collector is known from EP 1 811 245 that is produced in such a manner that a first metal sheet into which a passage system was embossed is connected to a second plain metal sheet. The connection is realized by soldering.

From EP 0 286 399 [U.S. Pat. No. 4,955,435] a method of making a heat exchanger is known according to which plates consisting of a suitable polymer material to which a corresponding passage system for the passage of a fluid is embossed are connected by adhering or welding by heat sealing.

Accordingly, layers of plastic are connected by the method cited at last. According to the method cited at first metal layers are connected by the application of a soldering plating and by a soldering method. However, this method is expensive. According to the method cited at last no metal layer is used.

It is the object of the present invention to provide a method of making a low-pressure thin-walled heat exchanger that can be carried out in an especially cheap manner. Furthermore, according to the invention a low-pressure thin-walled heat exchanger is to be provided that can be produced in an especially cheap manner.

According to the invention this object is attained by a method of making a low-pressure thin-walled heat exchanger comprising the following steps:

providing a thin metal cover layer;

providing a thin layer consisting of a sealable polymer by the application of a coating onto one side of the metal cover layer and/or as a layer separate from the metal cover layer;

providing a second thin cover layer consisting of metal or plastic; and

sealing the two cover layers with one another by the interposed layer of the sealable polymer with the formation of a cavity suited for the passage of a heat exchange medium.

The present invention is directed to a method of making a low-pressure thin-walled heat exchanger that means that the heat is exchanger is exclusively proposed for low pressure applications, especially up to 2,5-3 bar (pressure of the heat exchange medium). Furthermore, the heat exchanger is to be especially used only for low temperature applications.

According to the present thin wall heat exchanger the cover layers used for the production of the heat exchanger have preferably a thickness between 0.01 and 1.5 mm wherein especially a thickness of 0.2 mm is used. Especially a metal foil or plastic foil is used as metal layer or plastic layer. However, corresponding metal sheets of thicker plastic layers can be used, too.

Since a thin material, especially a foil material that can be produced in a rotatory manner and that can be provided, for instance, as metal web or plastic web (as composite material) is used in the inventive method for the production of the heat exchanger a cheap production process can be used for the production of this material. Especially, an aluminum layer, especially an aluminum web, preferably with a suitable polymer coating, is used as metal layer.

Another advantage resides in the fact that according to the invention either a composite material (metal cover layer with coating of sealable polymer) or a separate layer of a sealable polymer is used so that an expensive method is not necessary in order to apply a suitable connection medium, for instance, a solder plating. The composite material has a coating of a sealable polymer that is applied onto one side of the metal layer, for instance, by lamination, extrusion or as sealable varnishing. The sealable polymer serves as connection material. The second thin cover layer of metal or plastic can also have such a coating of a sealable polymer. However, it can be also used without coating for the inventive method wherein in this case the metal layer or plastic layer is preferably provided with a primer in order to be able to generate a connection with a sealable polymer of the other cover layer or with the separate layer of the sealable polymer.

Accordingly, with the invention not only a simple and cheap application of the connection material but also a simple and cheap connection method is realized that can be done by a corresponding sealing process.

According to a special embodiment of the inventive method two cover layers are used that are respectively provided with a coating of a sealable polymer and that are sealed with one another. Of course, the sealing is realized with the formation of a cavity suited for the passage of a heat exchange medium.

According to another embodiment of the inventive method a cover layer provided with a coating of a sealable polymer is sealed with a second cover layer provided with a primer without polymer coating. Such primers, especially primers for metal layers, especially aluminum layers are known to the expert in the art. For instance, such primers can comprise varnish systems on epoxy, polyurethane or acryl basis. Such primers can be also used if a second cover layer of a suitable plastic is used. When using cover layers of metal, especially aluminum, for the inventive method it is secured that the cover layers have a sufficient impermeability with regard to the heat exchange medium. If a cover layer of plastic is used, such a plastic layer is preferably provided with an additional barrier layer in order to care for the requested impermeability in this manner.

In each case a cover sheet of metal is to be used with the inventive method for the production of the thin wall heat exchanger in order to care for a good heat transfer. According to the invention the metal layer is brought in a sealable condition either by applying the coating of a sealable polymer or by arranging a layer of a sealable polymer separate from the metal layer.

When the two cover layers are sealed with one another by an intermediate layer of a sealable polymer separated here from untreated cover layers, primed cover layers or cover layers provided with a layer of a sealable polymer can be used. Untreated or primed cover layers can be also used for the production of the composite cover layers.

As regards the shape or construction of the thin wall heat exchanger, according to a first embodiment, the two cover layers can be sealed with one another only at the edge so that a cavity suited for a two-dimensional passage of the heat exchange medium results. According to another embodiment the two cover layers are sealed in such a manner that a passage system for the passage of the heat exchange medium results. Corresponding intermediate embodiments through the arrangement of webs, ribs etc. can be also used without any problems by the inventive method.

When a separate layer of a sealable polymer is used the same is arranged between the two cover layers and is sealed with them. When doing this an intermediate layer of a sealable polymer corresponding to the shape of a cavity or of the passage system is used. To this end the polymer intermediate layer can be stamped out in such a manner that the generated cavities form the cavity or the passage system for the heat exchange medium. Of course, the corresponding cavities can be also produced by other methods, for instance, mechanical or chemical separation methods as etching, screen-print etc.

According to still another embodiment of the inventive method a cavity or a passage system for the passage of the heat exchange medium is embossed into at least one cover layer prior to the sealing. According to this variant of the method with which a cavity or a passage system is produced by mechanical embossing, a second polymer-coated cover layer that is plain or a cover sheet into which also a cavity or a passage system is embossed can be used. Accordingly, in the embodiment cited at last the embossed passages of the two cover layers form together a two-sided passage system for the passage of a heat exchange medium after the connection.

According to another embodiment the two cover layers are sealed with one another for the formation of a cavity for a two-dimensional passage or of a passage system and the cavity of the passage system is expanded by the application of pressure. Here the sealing is carried out in a special pattern wherein the non-sealed portions form the cavity or the passage system for the heat exchange medium. Then, these portions are inflated, for instance, with a suitable gas (air) so that they can be passed by the heat is exchange medium then. Here also the heat exchange medium itself can be used for the expansion of the cavity or passage system.

According to an improvement of the inventive method the cavity or the passage system is provided with connection members during or after the sealing. These connection members can, for instance, consist of a material that can be sealed or tightly jammed with a polymer coating of the metal layers. Such a connection member can be, for instance, a polymer hose, a polymer tube etc.

According to the inventive method the sealing is preferably carried out as ultrasonic sealing. In this manner the cover layers and/or the intermediate layer can be connected with one another especially easily wherein corresponding sealing patterns for passage systems can be produced in an especially simple manner. Hot sealing methods, laser welding methods or other sealing methods can be used.

The sealable coating or the separate sealable layer includes a sealable polymer that can be preferably polypropylene, polyamide, PC or combinations (coextrusion). The polymer coating is preferably applied in a thickness of 0.01-0.3 mm. The separate sealable layer has a corresponding thickness.

According to another preferred embodiment of the method at least one cover layer is provided with a protection layer on one side or on both side sides in order to improve the corrosion resistance, for instance. This protection layer can be, for instance, a varnish or an elox layer.

Furthermore, the applied coating or the separate layer of the sealable polymer can be provided with additives, for instance CNT (carbon nano tubes), in order to improve the thermal conductivity.

The sealing can be carried out by sealing the whole range outside of the cavity or the passage system or by using only a part of the range for sealing. For this connection, for instance, corresponding sealing seams can be carried out in different widths and different structures/profiles.

Furthermore, the present invention is directed to a low-pressure thin-walled heat exchanger comprising a first thin cover layer of metal, a second thin cover layer of metal or plastic and a connection layer between the two cover layers consisting of a sealable polymer wherein a cavity or passage system for a heat exchange medium is formed between the cover layers.

Preferably, the metal cover layer consists of aluminum or comprises an aluminum layer. The connection layer between the two cover layers is formed either of an intermediate layer of a sealable polymer separate from the two cover layers or of at least one coating of the first or second cover layer.

The connection layer is formed in such a manner that the heat exchanger has a cavity or a passage system for a heat exchange medium between the cover layers. As cavity a larger free space is defined, for instance, a central cavity according to which the connection layer is only located in the edge range of the heat exchanger. Corresponding passage systems can comprise any designed flow passages for a heat exchange medium, for instance, those which are form in a meandering manner.

With the term “connection layer” not exclusively a two-dimensional connection is meant but this term is to cover also linear connection ranges in the form of connection seams. The invention is directed not only to thin wall heat exchangers according to which the two cover layers are connected by two-dimensional connection ranges but also to such heat exchangers according to which the connection is realized by linear connection ranges in form of connection seams.

According to a special embodiment at least one cover layer has an embossed cavity or an embossed passage system. The other cover layer can be plain so that a one-sided cavity or a one-sided passage system results or both cover layers can include an embossed cavity or an embossed passage system so that a two-sided cavity or a two-sided passage system results after sealing. Both cover layers are sealed at their contact points either through the whole contact ranges or through a part thereof. The connection layer by means of which the two cover layers are sealed with one another extends here over the contact ranges or a part thereof. If the connection layer is formed by a polymer coating that extends over the whole area of the cover layer only the contact ranges of the layer form the connection layer.

According to another embodiment the connection layer is provided with the formation of a cavity or of a passage system between the cover layers. Here an intermediate layer of a sealable polymer is used that is already provided with a cavity or passage system prior to the sealing. Accordingly, the intermediate layer defines the cavity or the passage system that can be engraved into the intermediate layer, for instance.

According to still another embodiment the cavity or the passage system is formed by expansion by pressure application. In this case, for instance, the basic shape of the cavity or of the passage system is defined by the kind of sealing in a certain pattern. Thereafter, the cavity or the passage system obtains its final shape by expanding or inflating. Since the heat exchanger is correspondingly flexible, this design can be produced without any problems either by the application of pressure with a special expanding medium (air) or by the application of pressure with the heat exchange medium itself (with or without a mold).

The heat exchanger formed according to the invention has a simple construction and can be produced in a cheap manner, as indicated above. As metal layer preferably metal foils but also metal sheets, especially aluminum foils or aluminum sheets, are used wherein a metal layer in a thickness range between 0.05-1.5 mm is preferred. Accordingly, dependent on the thickness of the used material the produced heat exchanger is correspondingly flexible and can be used for applications that make necessary such a flexibility.

Preferably, the heat exchanger has connection members for the cavity or the passage system, for instance, polymer hoses or polymer tubes that are especially mechanically jammed or welded with the connection portions of the cavity or of the passage system.

The heat exchanger of the invention can be used in a versatile manner, especially for low pressure applications according to which the heat exchange medium is under a pressure up to 2.5-3 bar and has preferably a correspondingly low temperature. It comprises preferably two cover layers of metal that can be produced by rotation as thin materials preferably in the shape of a composite material and do not make necessary an additional connection medium. Accordingly, a cheap production process can be realized. On the other side, high thermal conductivity values can be attained by the metallic cover layers. The inventive heat exchanger can be used, for example, by jamming, sealing or adhering, behind photovoltaic modules as heat exchanger, in heat accumulators, in air-conditioning ceilings/floors in buildings or in technical devices, in electronic devices for panel cooling etc. In a preferred application the heat exchanger forms a part of a photovoltaic module and is arranged under the back sheet thereof for heat recovery.

In the following the invention is described by means of examples in connection with the drawing in detail. Of the drawing

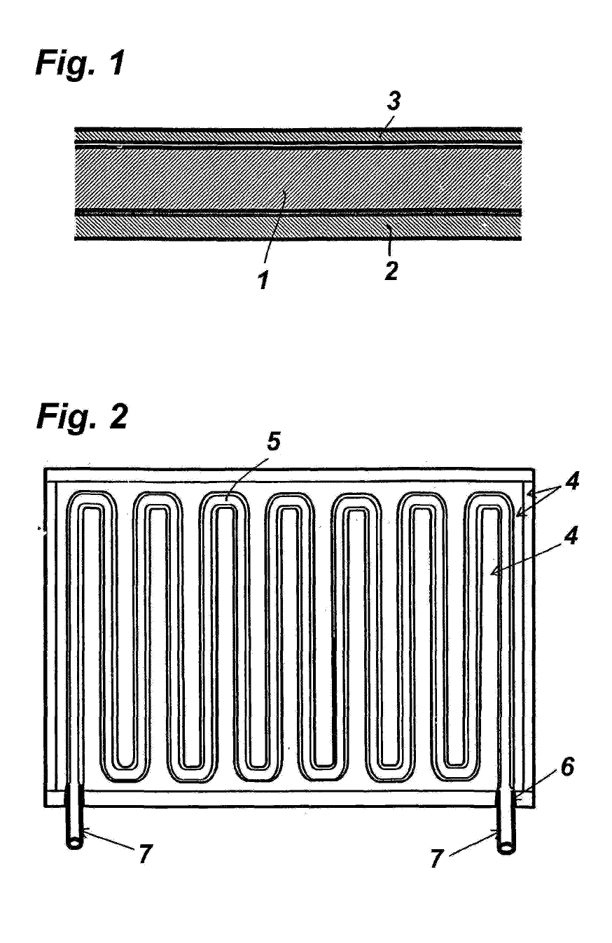

FIG. 1 shows a vertical section through a coated metal layer for a low-pressure thin-walled heat exchanger;

FIG. 2 shows a top view of a first embodiment of a low-pressure thin-walled heat exchanger;

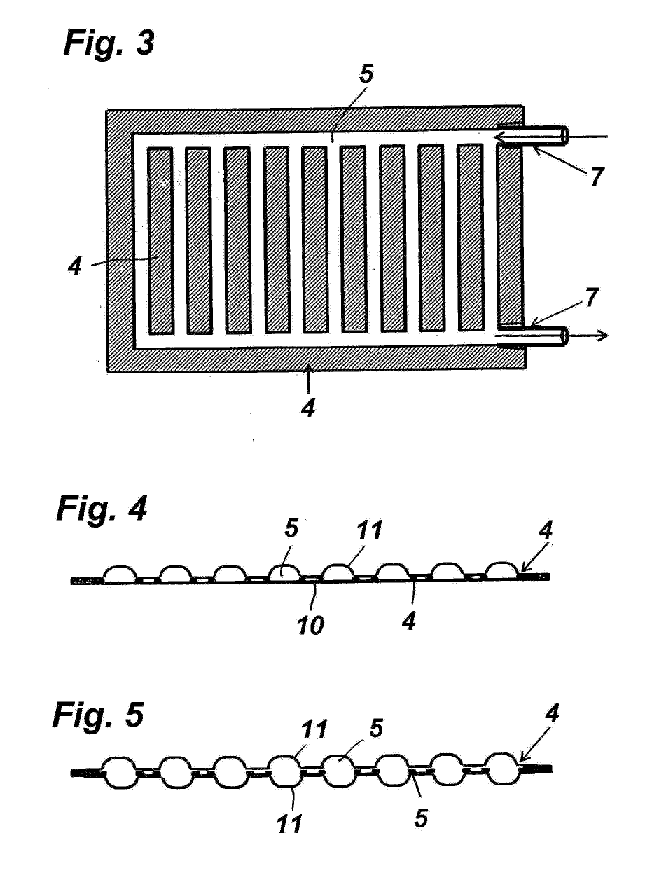

FIG. 3 shows a top view of a second embodiment of a low-pressure thin-walled heat exchanger;

FIG. 4 shows a vertical section through a low-pressure thin-walled heat exchanger with one-sided embossing;

FIG. 5 shows a vertical section through a low-pressure thin-walled heat exchanger with two-sided embossing;

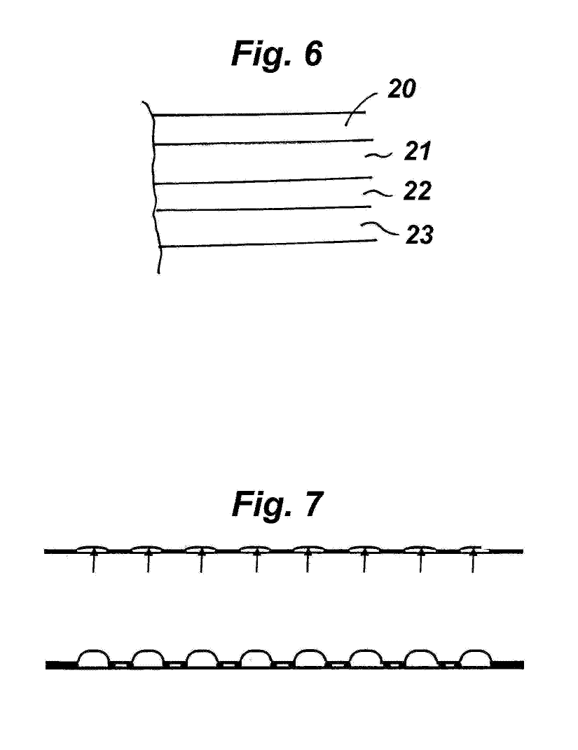

FIG. 6 shows a schematic vertical section through a photovoltaic module; and

FIG. 7 shows a vertical section through a thin wall heat exchanger prior to and after expanding.

FIG. 1 shows a vertical section through a coated metal layer that is used for the production of a low-pressure thin-walled heat exchanger or foil heat exchanger. A coated metal layer consists of a central aluminum layer 1 having, for instance, a thickness of 0.2 mm, a polymer coating 2 and a layer 3 of a protecting lacquer. The layer 3 of the protecting lacquer forms the outer side of the layer while the polymer coating 2 forms the inner side. The polymer coating 2 is a layer of polyamide that has been applied onto the aluminum layer 1 by laminating. Accordingly, the polymer coating 2 is a sealable polymer layer that can be sealed with another polymer coating.

FIGS. 4 and 5 show in vertical section two embodiments of low-pressure thin-walled heat exchangers that consist of two material layers according to FIG. 1, respectively. In the embodiment shown in FIG. 4 a smooth or plain material layer 10 is used that is connected with an embossed material layer 11. The layer 11 has an embossed passage system 5 for a heat exchange medium. In the portions characterized with 4 both layers 10, 11 are sealed with one another by their polymer coating, for instance, by an ultra sonic sealing.

FIG. 5 shows an embodiment according to which both layers 11 have an embossed passage system 5. After sealing both systems form a general system.

FIGS. 2 and 3 show two embodiments of low-pressure thin-walled heat exchangers with different embossed passage systems 5.

FIG. 2 shows a meandering passage system 5 wherein the portions outside of the passage system 5 form sealing portions 4. Corresponding connection members 7 in the form of polymer hoses are connected to the passage system 5, for instance, by sealing by another sealing medium 6.

FIG. 3 shows an embodiment of a heat exchanger according to which the passage system 5 is differently formed. Here the corresponding sealing portions are also designated with 4. Suitable connection members 7 are provided.

FIG. 6 shows a schematic vertical section through a photovoltaic module consisting of a cover layer 20, a bedding layer 21 into which the photocells are bedded and a back sheet 22. A low-pressure thin-walled heat exchanger of the kind that is described here is arranged below the back sheet 22 as further layer 23 and is used for the recovery of heat wherein the recovered heat can be discharged by the heat exchange medium passing the heat exchanger. The low-pressure thin-walled heat exchanger is adhered to the back sheet of the photovoltaic module, for instance.

FIG. 7 shows an embodiment of a low-pressure thin-walled heat exchanger that gets its final shape by expanding. The heat exchanger is produced by sealing the two cover layers so that a passage system is obtained, as shown in the upper picture of FIG. 7. Thereafter, the passage system is expanded by the application of pressure (pressurized air) so that the permanent final shape shown in FIG. 7 below is obtained. Then the passage system can be passed by a suitable heat exchange medium.

1. A method of making a low-pressure thin-walled heat exchanger with the following steps
providing a thin metal cover layer;
providing a thin layer consisting of a sealable polymer by the application of a coating onto one side of the metal cover layer and/or in the form of a layer separate from the metal cover layer;
providing a second thin cover layer consisting of metal or plastic; and
sealing the two cover layers with one another by the interposed layer of the sealable polymer and forming between the cover layers a cavity suitable for the passage of a heat-exchange medium.

2. The method according to claim 1, wherein two cover layers are used that are provided with a coating of a sealable polymer, respectively, and that are sealed with one another.

3. The method according to claim 1, wherein a cover layer provided with a coating of a sealable polymer is sealed with a second cover layer provided with a primer without polymer coating.

4. The method according to claim 1, wherein the two cover layers are sealed with one another by a separate intermediate layer of a sealable polymer.

5. The method according to claim 1, wherein the two cover layers are sealed with one another only at their edge so that a cavity suitable for a two-dimensional passage of the heat-exchange medium results.

6. The method according to claim 1, wherein two cover layers are sealed with one another in such a manner that a passage system for the passage of the heat-exchange medium results.

7. The method according to claim 1, wherein a sealable polymer intermediate layer corresponding to the shape of a cavity or of a passage system is used.

8. The method according to claim 1, wherein a cavity or a passage system for the passage of the heat-exchange medium is embossed into at least one cover layer prior to the sealing.

9. The method according to claim 1, wherein the two cover layers are sealed with one another for the formation of a cavity for a two-dimensional passage or of a passage system and that the cavity or the passage system is expanded by the application of pressure.

10. The method according to claim 1, wherein the cavity or the passage system is provided with connection members during or after the sealing.

11. The method according to claim 1, wherein at least one cover layer is provided with a protection layer on one side or on both sides.

12. A low-pressure thin-walled heat exchanger comprising:
a first thin cover layer consisting of metal,
a second thin cover layer consisting of metal or plastic and forming with the first cover a cavity or passage system for a heat-exchange medium, and
a connection layer between the two cover layers consisting of a sealable polymer.

13. The low-pressure thin-walled heat exchanger according to claim 12, wherein at least one cover layer is embossed to form the cavity or passage system.

14. The low-pressure thin-walled heat exchanger according to claim 12, wherein the connection layer is is formed between the cover layers with the cavity or passage system.

15. The low-pressure thin-walled heat exchanger according to claim 14, wherein the cavity or the passage system is formed through expanding by the application of pressure.

16. The low-pressure thin-walled heat exchanger according to claim 12, wherein the heat exchanger forms apart of a photovoltaic module and is arranged under the back sheet thereof for the recovery of heat.

17. The low-pressure thin-walled heat exchanger according to wherein the heat exchanger is produced according to the method of claim 1.
